(19) United States
(12) Patent Application Publication
(10) Pub. No.: US 2018/0034923 A1
(43) Pub. Date: Feb. 1, 2018

(54) DEVICE DISCOVERY FRAMEWORK

(71) Applicant: Microsoft Technology Licensing, LLC, Redmond, WA (US)

(72) Inventors: Rouella Joan Mendonca, Redmond, WA (US); Cristian M. Matesan, Seattle, WA (US); Yi-Chang Richard Shen, Seattle, WA (US); Gianluigi Nusca, Seattle, WA (US); Andrew T. Baron, Seattle, WA (US); Anders Edgar Klemets, Redmond, WA (US); Vishal A. Mhatre, Redmond, WA (US); Darren R. Davis, Seattle, WA (US)

(21) Appl. No.: 15/224,547

(22) Filed: Jul. 30, 2016

(51) Int. Cl. H04L 29/08; H04W 76/02; H04W 48/16; H04L 12/24

(52) U.S. Cl. CPC H04L 67/16; H04L 41/12; H04L 67/36; H04W 76/02; H04W 48/16

(57) ABSTRACT

A computing device is provided with a discovery framework that may include a discovery user interface (UI) and a discovery engine configured to use various standard discovery protocols in a protocol stack of the computing device. The discovery engine may respond to an invocation of the discovery framework by determining discovery criteria and based thereon selecting one of the discovery protocols, requesting discovery through the selected discovery protocol, receiving corresponding first discovery results, and maintaining a discovery list comprised of indicia of devices discovered through at least the selected discovery protocol. The discovery UI allows interactive adjustment of the discovery criteria, displays the discovery list, and responds to selection of a discovered device in the discovery list by enabling a connection with the discovered device based on a network address of the discovered device obtained through one of the discovery protocols.

### BACKGROUND

Devices often communicate with each other over networks to exchange information. For any two devices that need to exchange data, network communication can potentially involve many protocols, from the application layer down through the link layer. In some cases, two devices may have software that implements a same application-layer protocol. For discussion, the software might be peer components on respective devices, where the peer components are to exchange information according to the application-layer protocol. Although the two devices might be capable of forming a network connection through which their peer components might exchange messages, such an exchange can be difficult when a network connection cannot be formed because one peer is not aware of the other peer's existence or in particular its network address.

This kind of connectivity problem often occurs when the application-layer protocol implemented by the peers assumes that one or more particular lower layer protocols are available for discovering other devices on the network. For instance, the application-layer protocol might be a media streaming protocol designed to use a WiFi advertising mechanism to discover other WiFi devices. One of the peer devices might not implement the advertising mechanism, or, the devices might be out of range of each other. Although the peers might be capable of exchanging their application-layer data if a network connection were established, the inability to discover each other prevents such communication. They might be incapable of “seeing” each other using the link-layer discover mechanism, and yet a network/transport layer connection—and hence peer communication—would be possible if they were able to discover each other through other means.

Device-to-device connectivity at the application layer can be difficult due to other problems. For example, a network discovery mechanism at any layer might discover an excessive number of nodes, perhaps in the hundreds or thousands. If all such discovered devices are provided to an application and displayed for a user to select a target device for the application to connect to, the large number of devices shown makes it difficult for the user to find a suitable or particular device. In addition, many of the devices might not be relevant to the current conditions, application, user, etc. The user might know that the desired target device is in the same room, is within a certain radio range is on a same network segment, or is a certain type of device, and yet devices that do not meet those conditions are displayed for potential selection by the user.

In addition, any given device needing to form a connection might have many mechanisms available for device discovery. A device might have application-level discovery mechanisms such as directory services, Domain Name System (DNS) discovery protocols such as DNS-SD (Service Discovery) and the Simple Service Discovery Protocol (SSDP). The device might also have discovery features in its implementations of network-level protocols, such as Internet Protocol (IP) multicast extensions, the IPv6 Network Discovery Protocol (NDP), and others. Many link-layer protocols also include discovery facilities for discovering nodes available for a particular link-layer protocol. For example, Bluetooth has various types of broadcast beacons that announce or solicit device presence. WiFi Direct also has advertise/discover functions.

For a network with many and various devices, there might be dozens or hundreds of protocols that any two devices might potentially use to discover one another. However, most application-level software is coded to inflexibly use only one or a few discovery mechanisms. If multiple discovery mechanisms are used, it is in an uncoordinated disjoint manner. For instance, if two different discovery mechanisms are used by one application, then there might be, respectively, two different user interfaces (UIs), two different paths of connection logic, two different purposes for discovery, etc. While a device might have four or five means for discovering other devices on the network or devices that are nearby and capable of link-level or network-level connectivity, any given application on that device might be configured to use only one of the discovery means and therefore fail to take advantage of its device's full discovery capability.

There is a need to allow arbitrary application-level software to transparently use a variety of network discovery mechanisms in a coherent manner and in a way that allows the scope and results of discovery to fit a current usage context.

### SUMMARY

The following summary is included only to introduce some concepts discussed in the Detailed Description below. This summary is not comprehensive and is not intended to delineate the scope of the claimed subject matter, which is set forth by the claims herein.

A computing device is provided with a discovery framework that may include a discovery user interface (UI) and a discovery engine configured to use various standard discovery protocols in a protocol stack of the computing device. The discovery engine may respond to an invocation of the discovery framework by determining discovery criteria and based thereon selecting one of the discovery protocols, requesting discovery through the selected discovery protocol, receiving corresponding first discovery results, and maintaining a discovery list comprised of indicia of devices discovered through at least the selected discovery protocol. The discovery UI allows interactive adjustment of the discovery criteria, displays the discovery list, and responds to selection of a discovered device in the discovery list by enabling a connection with the discovered device based on a network address of the discovered device obtained through one of the discovery protocols.

Many of the attendant features will be explained below with reference to the following detailed description considered in connection with the accompanying drawings.

### BRIEF DESCRIPTION OF THE DRAWINGS

The embodiments described herein will be better understood from the following Detailed Description read in light of the accompanying Drawings, wherein like reference numerals are used to designate like parts in the accompanying description.

FIG. 1 shows a discovery framework on a host.

FIG. 2 shows details of the discovery framework.

FIG. 3 shows details of how a discovery engine is used.

FIG. 4 illustrates how the scope of device discovery may change dynamically based on user steering through a user interface of the discovery framework.

FIG. 5 shows different discovery mechanisms that can be used by the discovery engine.

FIG. 6 shows how discovery results from various discovery protocols can be collected and normalized into a coherent namespace of unique device identities.

FIG. 7 shows an example of a master device identities table.

FIG. 8 shows an example of an application configured to use the discovery framework.

FIG. 9 shows the discovery user interface displayed by an application that uses the discovery framework.

FIG. 10 shows how the discovery user interface can interactively control the scope of device discovery.

FIG. 11 shows an example of the discovery user interface initiating a new connection.

FIG. 12 shows details of a computing device.

### DETAILED DESCRIPTION

Embodiments of a network discovery framework are discussed below. Discussion will begin with an overview of a network discovery framework and its general context. Major functions of a discovery framework are described next, followed by discussion of how a same discovery framework can manage multiple contexts or discovery sessions for multiple applications or the like. Next, dynamic user-controlled scoping and refinement of a discovery list is explained. Examples of standard underlying discovery mechanisms and protocols are then covered, including details of how to build the results of disparate discovery protocols into a coherent normalized set of discovered devices. Finally, uses and features of a user interface provided by a discovery framework are described.

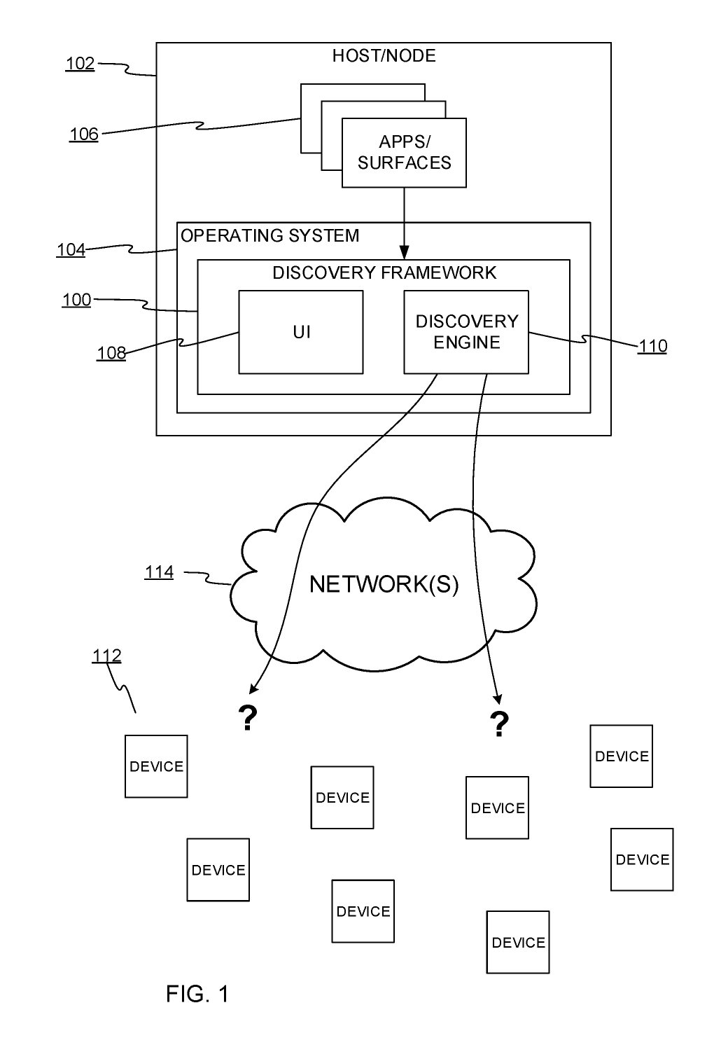

FIG. 1 shows a discovery framework 100 on a host 102. The discovery framework 100 is shown as part of an operating system 104. However, the framework can be implemented in any way that makes it available to arbitrary application-level code that needs to discover devices for connecting thereto. For example, the framework may be a shared library, a background service, a component of a managed runtime environment, etc. Generally, the discovery framework 100 is accessed through some form of software interface, application programming interface (API), interprocess communication, or the like. The framework can be invoked and used by any software on the host 102. For instance, different applications 106 might each interface with the discovery framework 100. However, any code can invoke the framework. For example, a graphical user shell might have different elements that each have their own connectivity and discovery needs; each element may use the discovery framework in a customized way. As discussed below, in one embodiment, the framework manages a different context for each instance of its use or invocation by an application or other software.

The discovery framework 100 has two major functions or modules, namely, a discovery UI 108 and a discovery engine 110. The discovery UI 108 (or instances thereof) is displayed in the windows of the application-layer code where device discovery is needed. Alternatively, the discovery UI has its own window. The discovery UI 108 is for (i) allowing a user to interactively steer the discovery engine's discovery of devices and shaping the results, (ii) displaying indicia of the discovered devices (e.g., a list of device names and pieces of device information), and (iii) allowing discovered devices to be interactively selected and in response configured for connectivity, for instance by assigning the network name/address of the selected device to an application-level configuration setting, and/or initiating network-level and/or application-level connectivity to the selected device, etc.

The discovery engine 110 discovers devices as specified by the discovery UI 108 and/or discovery criteria. The discovery engine 110 is configured to interface with a variety of standard discovery protocols. The discovery engine 110 manages the discovery of devices 112 over one or more networks 114 according to various conditions, underlying discovery protocols, or discovery features of communication protocols. The discovery engine 110 uses arbitrary and perhaps standard discovery protocols to collect information about the devices 112. The devices 112 can be any type of device with the means to potentially communicate with the host 100. For example, devices 112 may be mobile phones, laptops, appliances with network connectivity, virtual machines, servers, displays such as projectors, sensors, printers, and so on. As discussed below, the discovery engine 110 collects responses to discovery requests, normalizes the discovery information, and provides indicia of discovered devices 112 for display and selection in the discovery UI 108. As used herein, “discovery protocol” refers to any communication protocol either specifically designed for device discovery or any communication protocol that includes a component for device discovery.

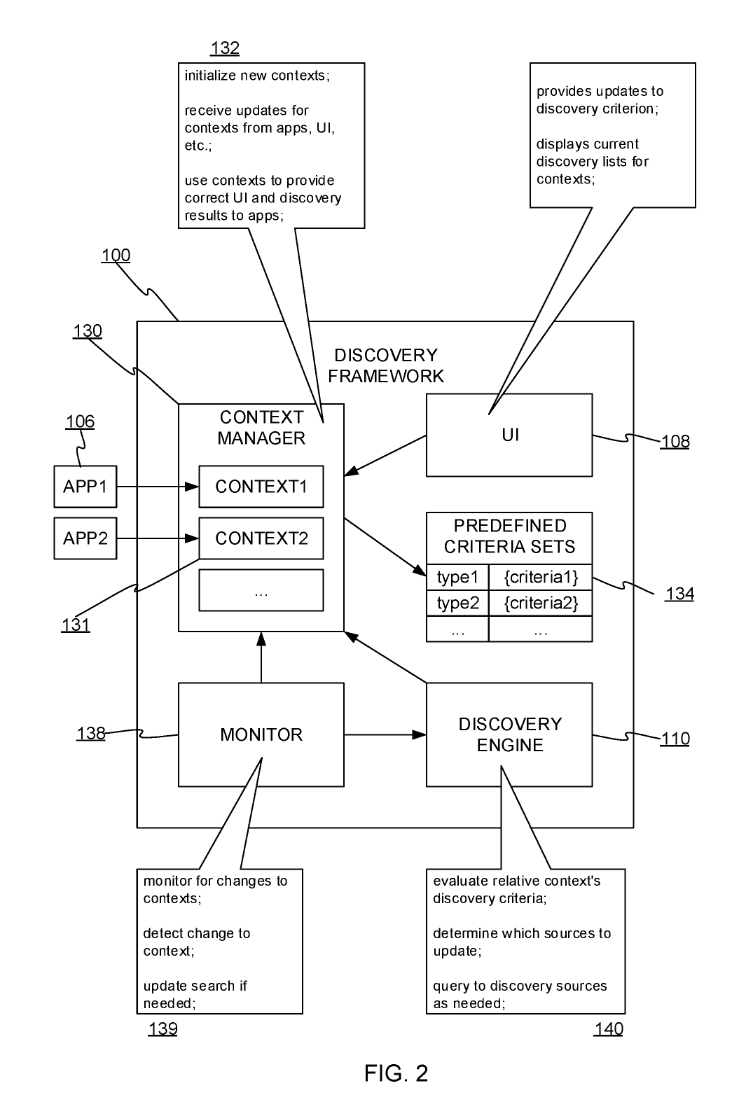

FIG. 2 shows details of the discovery framework 100. As noted, any arbitrary code such as applications 106 can invoke the discovery framework through an API or the like. The discovery framework 100 has a context manager 130 to keep track of sessions or individual invocations of the discovery framework 100. When an application invokes the discovery framework 100, a new context 131 is created and associated with the invoker. The context 131 stores all of the discovery state for the corresponding invoker, for instance, discovery criteria, user interface state, etc. The context manager 130 creates and manages the lifetime of contexts 131. The context manager 130 also performs processes 132 for instantiating contexts 131, handling updates to contexts, and using the contexts to provide each application 106 or other invoker with the correct corresponding discovery results and the corresponding state of the discovery UI 108. Thus, each piece of code using the discovery framework 100 appears to have its own independent discovery mechanism with its own individual state, yet resources of the discovery framework such as discovery functionality, UI appearance and logic, and underlying discovery results can be shared. In one embodiment, contexts are partly persisted. For instance, when an application has invoked the framework, if the application specifies some discovery parameters, or if the discovery UI 108 is used to express preferences for displaying or filtering discovery results, or if a discovered device is selected for a connection, etc., then this type of information is persisted in the corresponding context after the application terminates or otherwise ends its session with the framework. When the application again invokes the framework, for instance after a new execution of the application, then the application can continue with at least some of its prior discovery state.

As noted above, a new context might be initialized with various values. In one embodiment, a discovery type is associated with the new context. This might be done explicitly by the invoker passing in an explicit type parameter (e.g., “type1”) or implicitly by inferring a type from features of the invoker. The type, if any, is looked up in a table 134 of predefined discovery types, each having a respective set of discovery criteria. The looked-up criteria are copied in to the corresponding context to initialize the discovery criteria for that context. Once initialized, if at all, the discovery criteria for a context can be updated interactively by user interaction with the discovery UI 108. Alternatively, each new context is assigned default values.

In another embodiment, each invocation of the discovery framework creates a new autonomous instance of the discovery framework. In this case, context management is not needed and each framework instance has its own discovery configuration and data.

The discovery framework 100 may be implemented so that the discovery UI 108 acts as a near real-time regulator of the scope and content of discovery. When the discovery UI 108 is interacted with to, for example, expand or contract the scope of discovery for the corresponding context/application, any necessary additional discovery searches (e.g., using an additional discovery protocol) are responsively performed and results thereof may populate the discovery UI 108 with newly discovered devices. In this way, a user is able to evaluate what has been discovered and interactively contract or expand the scope of network discovery of devices. Similarly, the current set of discovery results can be interactively filtered, reordered, etc., and which discovered devices are displayed in the discovery results expands and contracts accordingly.

To enable this interactive steering of discovery and how discovery results are presented, a monitor 138 may be included. The monitor 138 may perform a process 139 that monitors for changes to contexts. When a change is detected the discovery engine 110 is informed and any needed actions are taken, such as issuing a new discovery request to the network. Similarly, the monitor 138 can monitor activity of the discovery engine 110 to assure that the discovery UI 108 remains consistent with the current discovery criteria. In some embodiments, discovery results are provided to the discovery UI 108 asynchronously so that the discovery UI 108 populates with indicia of devices as they are discovered.

The discovery engine 110 uses the various available discovery protocols (discussed below) to discover new devices, stores results, and normalizes or canonicalizes the results into a coherent set of discovered device identities. Discovery may be guided by the discovery criteria of a given context. When the monitor 138 detects a change to a context's discovery criteria, the discovery engine 110 may be signaled to update the discovery search for the context. In turn, a discovery process 140 is performed. The relative discovery criteria are evaluated by the discovery engine 110. The discovery engine 110 may determine whether the discovery search needs to be expanded with a new discovery source.

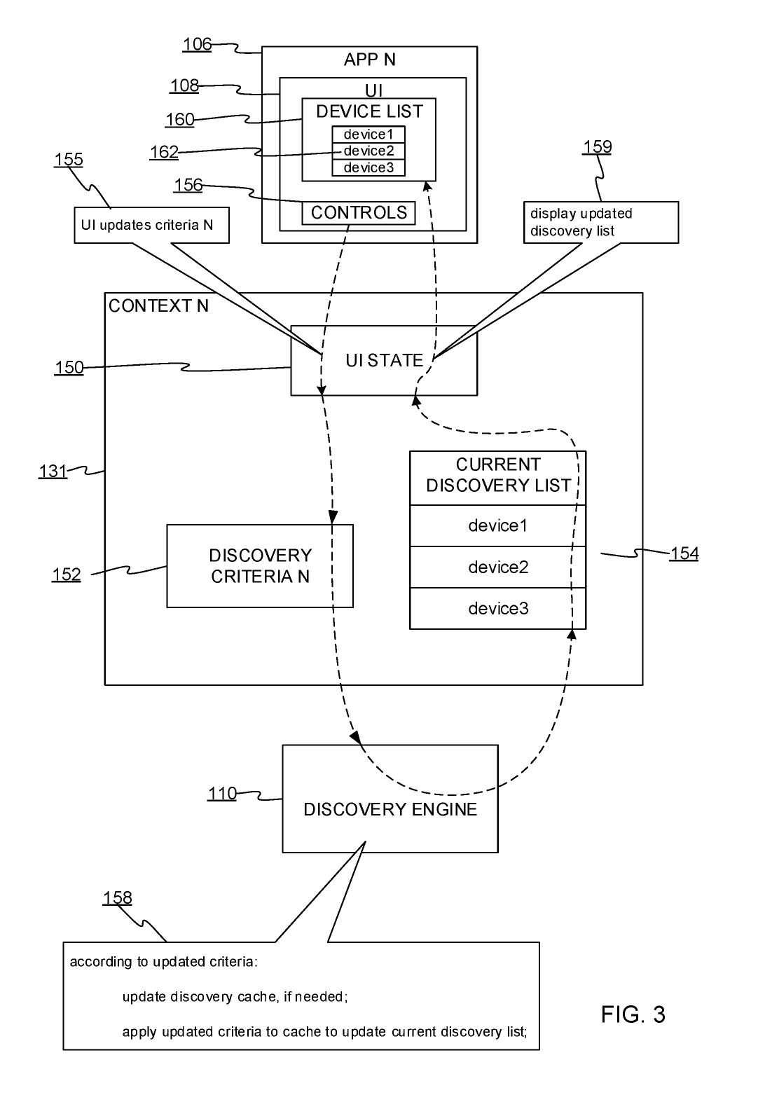

FIG. 3 shows details of how the discovery engine 110 is used. For discussion, it will be assumed that some application (“APP N”) or other software has invoked the discovery framework 100 and has a corresponding context 131 (“CONTEXT N”). The context 131 stores or accesses UI state 150, discovery criteria 152, and a current discovery list 154. At step 155, controls 156 of the discovery UI 108 may be manipulated by a user. For example, an “expand search” button might be activated, a new discovery criteria might be added, a search string might be inputted in a text box, a desired type of device might be selected, a minimal degree of proximity is inputted, etc. This change to the UI state 150 updates the discovery criteria 152 (the UI state and the discovery criteria may be one and the same). In response, at step 158 the discovery engine 110 evaluates the updated discovery criteria and performs any underlying discovery inquiries that might be needed. Alternatively or additionally, at step 159 the current discovery list 154 is updated, which flows through to a device list element 160; indications 162 of discovered devices reflect which devices have been discovered according to the updated discovery criteria 152.

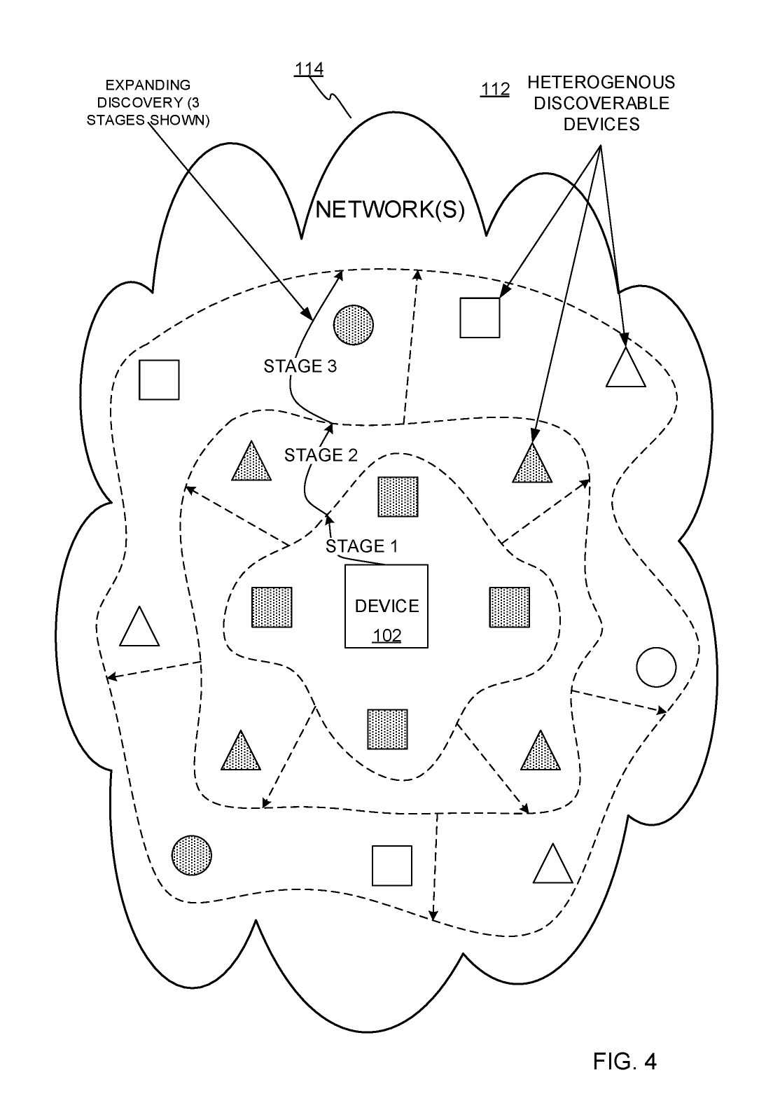

FIG. 4 illustrates how the scope of device discovery or the devices in the current discovery list 154 may change dynamically based on user steering through the discovery UI. The shapes and shades of the graphics representing discoverable devices 112 represent different discovery mechanisms or protocols that might be implemented by the devices, different filterable features of the devices, and so forth. That is, factors that might affect whether a device is discovered or considered relevant to current criteria. Initially, the operative device or host 102 invokes the discovery framework. The discovery framework may start with some initial discovery criteria, either explicitly seeded with initialization parameters by the caller of the framework, by default, by inference, according to a previously stored context of the invoker, etc. At this initial state (“STAGE 1” in FIG. 4), the discovery engine might determine that only a single discovery protocol is needed, for instance, a Bluetooth discovery packet might be broadcasted. Devices 112 that answer the Bluetooth discovery request are represented by shaded squares. Thus, the current discovery list at STAGE 1 includes four devices, some or all of which are displayed in the device list element 160. If, after this first stage of discovery, the user does not find a desired device, then the scope of discovery may be expanded either by explicit user input or automatically, for instance based on passage of time or other conditions such as passive receipt of advertisement beacons or packets.

At a next state of discovery (“STAGE 2”), the user may have indicated that additional discovery is needed. The discovery engine may expand the scope of discovery in a number of ways. For instance, a Bluetooth discovery might be initiated for additional device types or a lower minimum signal strength. A new discovery protocol might be added to the mix. As shown in FIG. 4, at the second stage the variety and number of discovered devices has been expanded. Similarly, if additional user input indicates that a desired device has still not been found, then the discovery may be expanded again (“STAGE 3”), for example, by invoking yet another search mechanism (e.g., multicast DNS) or loosening another search constraint. At each stage, the discovery UI might be updated to reflect the current discovery list, additional search constraints, result-ordering options, discovery options, etc. In some cases, adding filtering criteria might, counterintuitively, expand the number of discovery protocols in use. For example, if a string matching condition is inputted by a user, although this condition might reduce the number of displayed devices (by filtering), some form of DNS query might be added to the mix of discovery protocols.

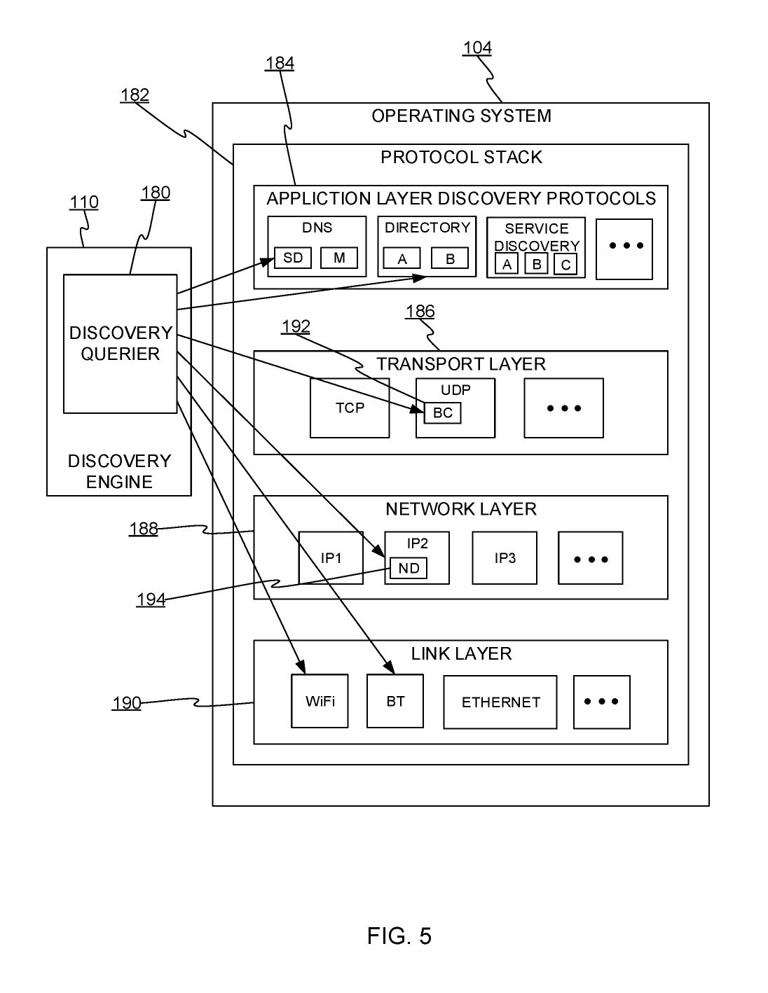

FIG. 5 shows different discovery mechanisms that can be used by the discovery engine 110. The discovery engine has a discovery querier 180 or similar component that is configured to interface with various discovery protocols. Regarding the discovery protocols, the host's operating system 104 has an ordinary communication or protocol stack 182, with modules or implementations of various communication protocols, some of which may be dedicated for discovery, others which may be communication protocols that happen to include a discovery mechanism (collectively referred to herein as “discovery protocols”). The discovery protocols can be used at any layer, including the application layer 184, transport layer 186, network layer 188, and link layer 190. In addition, some discovery mechanisms may be used that do not involve network communication, for example, Quick Response (QR) codes and inaudible sound.

Among the discovery protocols that might be used at the application layer 184 are various DNS mechanisms such as DNS Service Discovery (DNS-SD), Multicast DNS (M-DNS). Well known directory services may also be used, for instance various Lightweight Directory Access Protocol (LDAP) implementations, Active Directory (TM), Simple Network Management Protocol (SNMP), etc. Service discovery protocols may also be used to discover devices, such as Dynamic Host Configuration Protocol (DHCP), the Simple Service Discovery Protocol (SSDP), or others. At the transport layer 186 there may not be protocols dedicated to discovery per se, however, some of the transport protocols may have discovery components. For example, the Universal Datagram Protocol (UDP) may include a broadcast feature 192 that can be used to obtain addresses of answering devices. At the network layer 188, several features may be available. For example, the Internet Protocol (IP) Neighbor Discovery (ND) 194 defined by IP version 6, the Internet Control Message Protocol (ICMP), and others may be used for network-level discovery of devices. At the link layer 190 a number of mechanisms may be available. The WiFi protocols alone include several discovery protocols. WiFi Direct protocols define transmissions for advertising and discovery. WiFi infrastructure, Bluetooth, and Ethernet implementations may each include ways to discover devices. For instance Ethernet modules sometimes implement the Link Layer Discovery Protocol. It should be noted that aspects of protocols not specifically designed for discovery can nonetheless be used to obtain clues about available devices. Discovery protocols can be implemented in ways other than wired/wireless electromagnetic radiation. For example, some devices may be capable of sound transmission and detection and at inaudible frequencies, and sound can be used akin to modems for discovery. The examples above are illustrative; other and new protocols are contemplated.

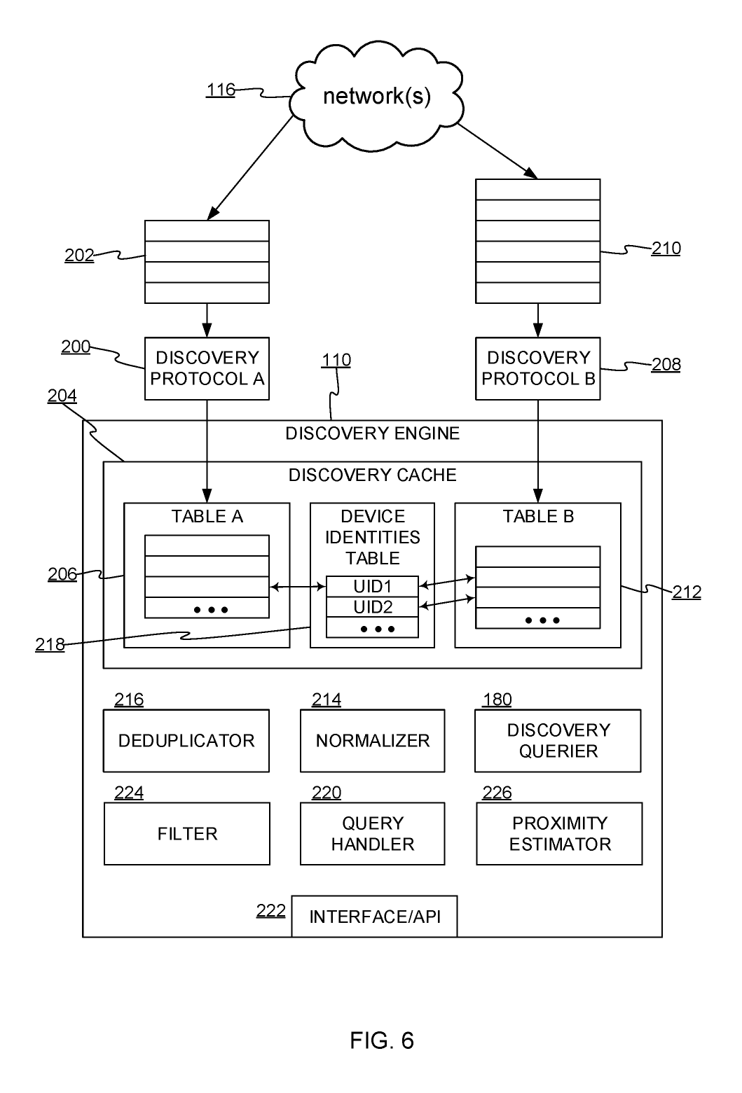

FIG. 6 shows how discovery results from various discovery protocols can be collected and normalized into a coherent namespace. The discovery engine 110 is configured with logic to determine which discovery protocols are needed at any given time for any given context. In FIG. 6, for some context and corresponding discovery criteria, the discovery engine 110 has determined initially that discovery protocol A 200 is needed. The discovery querier 180 is coded to interface with all of the available discovery protocols to formulate discovery requests and to receive results. Initially, a module or implementation of discovery protocol A 200 is instructed to issue a discovery request, for example, by formatting an appropriate message, packet, or frame and passing it out a corresponding network interface.

In response, the discovery querier 180 receives results 202 conformant to discovery protocol A. For example, the results might be DNS records, WiFi frames containing headers identifying devices that responded to the query, Bluetooth packets, or the like. Generally, results will contain, for each discovered device, one or more of: a network name and/or address (e.g., an IP address), a MAC address, metadata about the responding device, supported protocols, a Return Signal Strength Indicator (RSSI), or any other information of the type found in standard discovery protocols such as those discussed with reference to FIG. 5.

Because the results from different discovery protocols may have different fields, formats, etc., the raw results are stored in a discovery cache 204 and are normalized therefrom. Each discovery protocol may have a table or other data structure for storing results with the format and/or content of the corresponding discovery protocol. For example, table A 206 stores results 202. Each record in table A 206 corresponds to a device discovered through discovery protocol A. Similarly, if the discovery criteria of the current context changes, then the discovery engine 110 might determine that the scope of discovery needs to be expanded to include discovery protocol B 208. A module or implementation of discovery protocol B is used by the discovery querier 180 to formulate another discovery request compliant with discovery protocol B. When additional results 210 are received through the network protocol stack and passed to the discovery querier 180, the additional results 210 are stored in table B 212 which may be specifically for storing data from discovery protocol B. Alternatively, pointers to results stored in discovery protocol modules/implementations may be used.

Because an objective of the discovery framework is to provide a coherent device namespace from which a user can select devices to connect to, the discovery framework may have a normalizer 214 and a deduplicator 216. The normalizer maps incoming discovery protocol results to a device identities table 218 using any fields of information that can indicate an association with a same device. The device identities table 218 contains a single master record for each discovered device. When a discovery result is received, for instance results 202, for each device therein, if needed, a new master device record is added to the device identities table 218. The master record of a device might be populated with various fields from the results 202, for instance an IP address of the device, a name, an estimated range or proximity rank, pointers to other discovery results in the discovery cache 204 for the same device, and so forth. Each device may be assigned a Unique Identifier (UID) for the device namespace, and the UID functions as a key that links the discovery data of a device to its master record. The deduplicator 216 may consolidate duplicate master records using known deduplication techniques, remove duplicate result records, or otherwise detect and remove duplicate data.

In one embodiment, each context has its own independent discovery cache. In another embodiment, each context shares the discovery cache as possible; the discovery cache is the union of discovery data of all of the contexts. In another embodiment, no raw discovery protocol results are cached or stored in tables, and instead, all data is translated and copied into the master identities table 218 when received. Generally, the provenance of the discovery data of a discovered device should be tracked, since dynamic discovery scoping decisions may depend on which discovery protocols have already been used or not. For example, if a master record of a device has a link to results table A, then it can be determined that protocol A has already been used to discover that device. If each context has its own discovery cache, the set of used protocols can be determined from which results tables exist or contain data.

The discovery cache may or may not implement expiration logic. If discovery data is persisted, then the time to expire may depend on the particular discovery protocol, a type of the relevant context, or other factors. Generally, mobile devices will have short-lived discovery data, since the devices that are discoverable may depend on the changing location of the mobile device. That is, some devices may simply perform discovery protocol requests each time discovery data is needed for a given discovery protocol.

The discovery engine 110 may also have functionality or modules to provide access to the discovery data in the tables. For example, a query handler 220 may handle queries, received through an interface 222, for discovery data, by finding requested discovery data and returning same. A filter 224 may provide filtered views of the discovery data in the master device identities table. For example, if the discovery UI indicates that only wireless devices are to be discovered, then the filter 224 provides a corresponding subset of discovered devices. In effect the filter 224 provides a view of the master device identity table. In addition, a proximity estimator 226 may be included to populate the master device table with proximity measures or ranks. If RSSI data is available, then RSSI values can be used. Any means for estimating the physical proximity of a device may be used, and various factors can be combined in weighted fashion. For instance, RSSI data, indications of a device being in a same building or on a same network segment, discovered location data (e.g., GPS coordinates), etc., may be combined to estimate which devices are relatively closest.

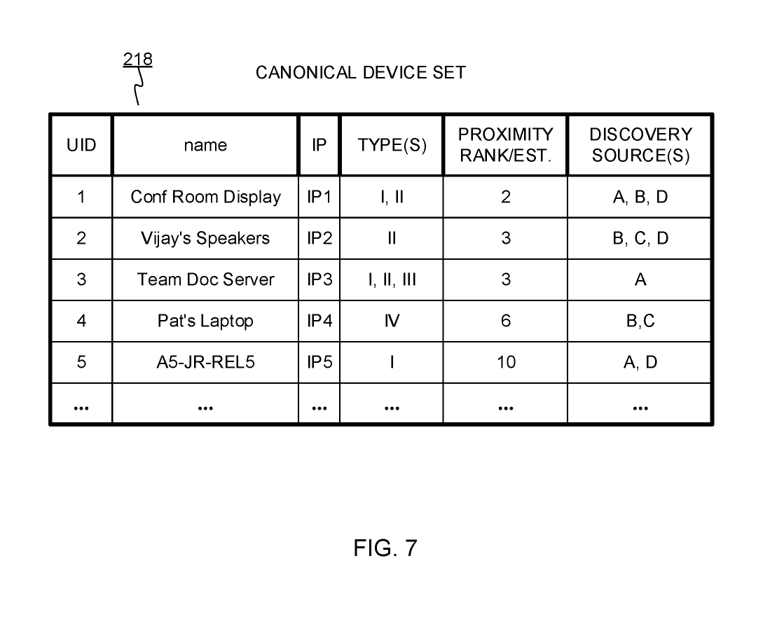

FIG. 7 shows an example of a master device identities table 218. Each record of a discovered device contains key discovered information, including for example a name or hostname, an IP address, an indication of the types of the device (e.g., speakers, display, an operating system), indicia of the discovery protocols used to find the corresponding device, a UID, and/or others. The device identities table 218 is the source of the list of discovered devices displayed in the discovery UI. The contents thereof (or a filtered subset) can be provided to the discovery UI by data binding, event-driven data updating, interprocess communication, software interfaces, etc.

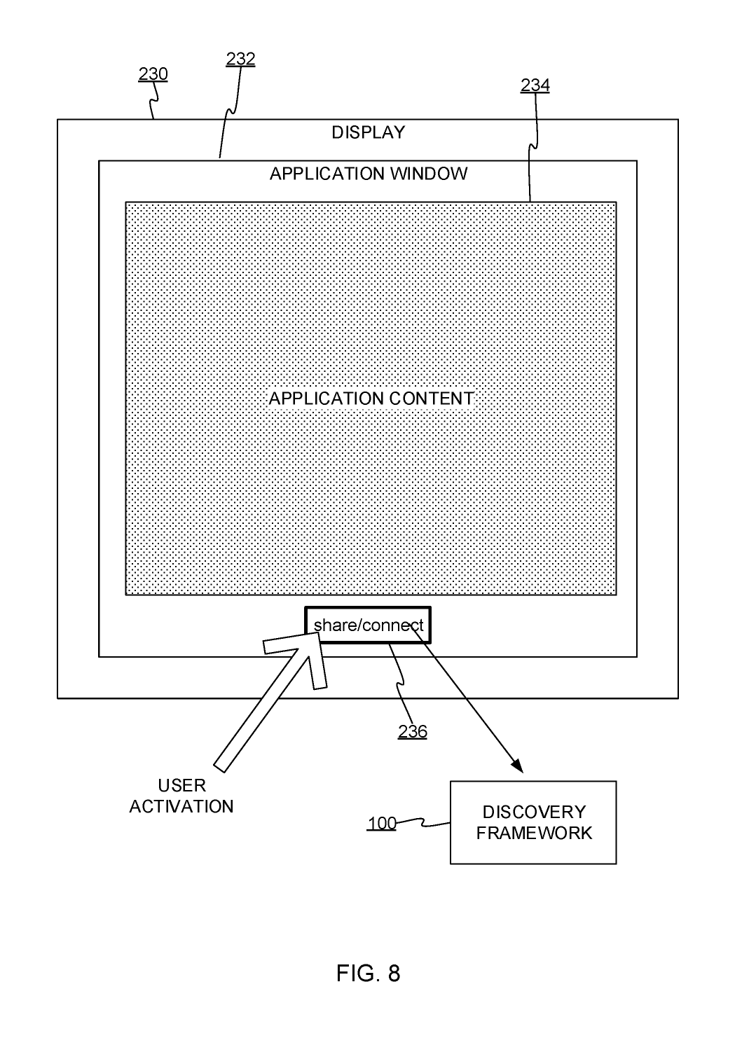

FIG. 8 shows an example of an application configured to use the discovery framework. A display 230 of the host 102 displays a window 232 of the application. The window 232 may display content 234 of any variety. The application is functionally linked to the discovery framework. For example, an operation or user interface element 326 might invoke the discovery UI. The operation might be related to a connectivity need of the application. For instance, if the application is about to attempt to connect to a peer application, then the discovery UI might be automatically displayed. If a user interface element 236 is used, for instance a button, then the discovery UI is displayed when the user interface element 236 is activated.

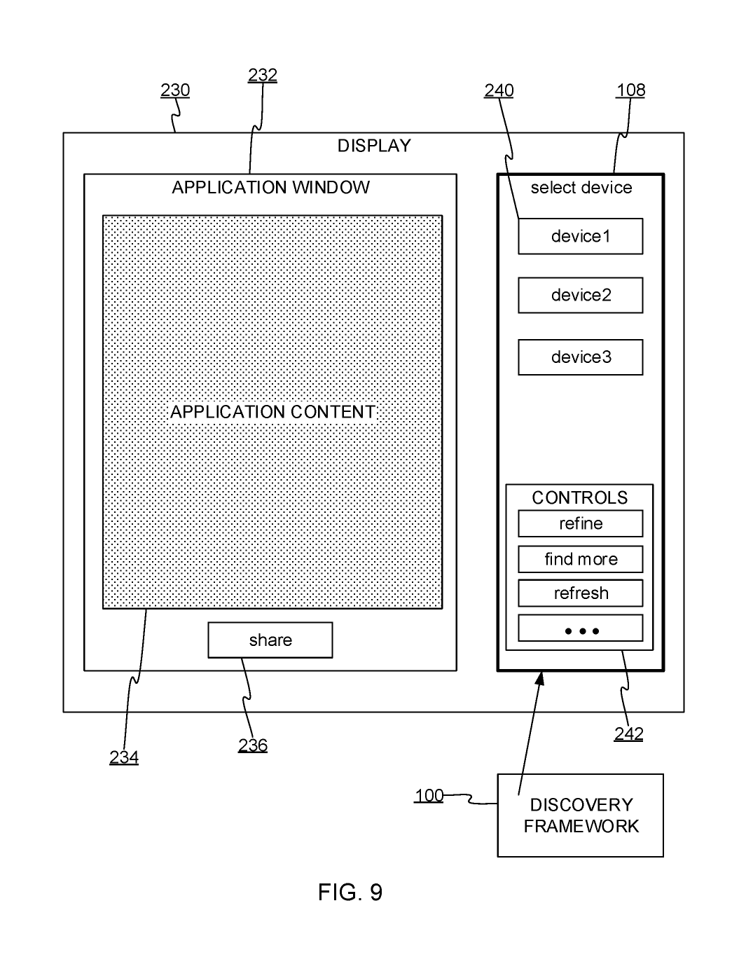

FIG. 9 shows the discovery UI 108 displayed by an application that uses the discovery framework 100. In the example of FIG. 9, the invocation of the discovery UI triggers a first automatic initial discovery request from one or more discovery protocols and the canonicalized discovered devices (the discovered device list) automatically populate the discovery UI. The discovery UI provides the ability to interactively select a device, for instance, in the form of selectable device indicators 240, a scrollable selector/cursor, a context menu, or the like. The discovery UI can be implemented, in some embodiments, to hide, delete its context, or take other actions if a device is selected. Moreover, selection of a device may trigger an application action such as attempting to form a connection with the selected device or setting a configuration setting to the selected device, its address, etc. As noted, in one embodiment, the discovery UI might automatically start to expand its scope of discovery automatically if a device is not selected after a threshold amount of time or in an insufficient number of devices are initially discovered.

The discovery UI may also have controls 242 to control the scope of discovery, filter the discovered device list, set an ordering criteria (e.g., by device name or proximity), refresh the search, etc. Filtering can be based on any type of discovery data or information associated with discovered devices. For example, indicia of previous connections or pairings at the application level may be stored and the discovered device list may be sorted to prioritize such devices or filtered to display only such devices. Devices may also be filtered or sorted based on device type, proximity, connectivity capabilities, and other features. As noted above, the displayed discovery list can be populated asynchronously as new discovery responses flow in from responding discovered devices. A string filter may also be included to allow the user to display only device a whose names and/or associated metadata contains a user-specified string.

The discovery UI may also include elements to enable a discovered device to be selected or designated. For example, each displayed discovered device may be represented by an interactive graphic that responds to user activation by triggering an event, initiating a network connection to be handed to the calling context (e.g., application) of the discovery UI, configuring the calling context to connect to the selected device, etc.

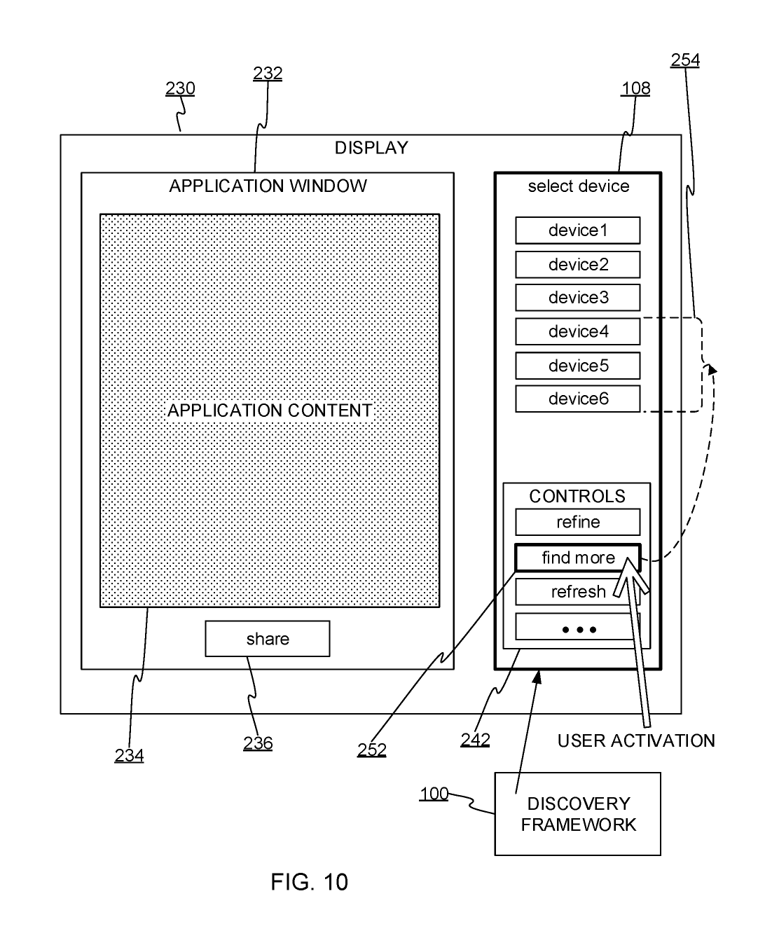

FIG. 10 shows how the discovery UI can interactively control the scope of device discovery. The controls 242 may include one or more elements, such as a find-button 252, that signal to the discovery engine that additional discovery is needed. Such a signal can also be implicitly generated responsive to passage of some threshold amount of time without selection of a device, too few devices having been found, scrolling to the end of the current discovery list, expansion of the current discovery criteria or filter conditions, etc. In any case, what is notable is the discovery framework providing arbitrary code with transparent abstract access to a suite of discovery protocols to discover connectable devices without exposing the user to details of the underlying discovery protocols, and with a consistent discover-and-connect experience regardless of the application or setting.

Returning to FIG. 10, when the find-button 252 or other feature of the discovery UI indicates that the scope of discovery needs to be extended, the discovery engine responds accordingly by adding indications of new devices 254 to the discovery list. For example, devices discovered by additional discovery protocols may be added, devices that less precisely fit the discovery criteria may be included, etc. In one embodiment, the discovery expansion adds or switches the discovery protocols that supply the current discovery list. In FIG. 10, activation of the find-button 252 leads to display of additional devices which can be selected.

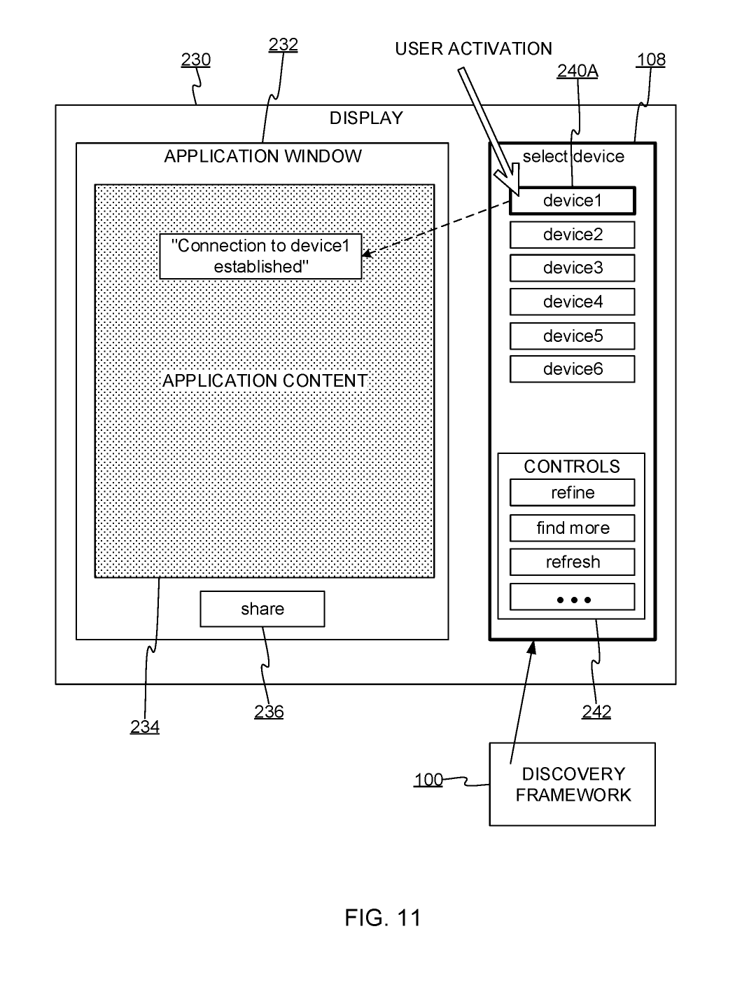

FIG. 11 shows an example of the discovery UI initiating a new connection. When indicator 240A for device1 is activated by a user input, because the device has been discovered with a discovery protocol, a network or media address of the device is available. That information, for instance from the master device table, is used to initiate a corresponding network-layer or link-layer connection to the selected device. As shown in FIG. 11, the application may use the new network connection to exchange data with a remote application, for instance, a peer, client, server, etc.

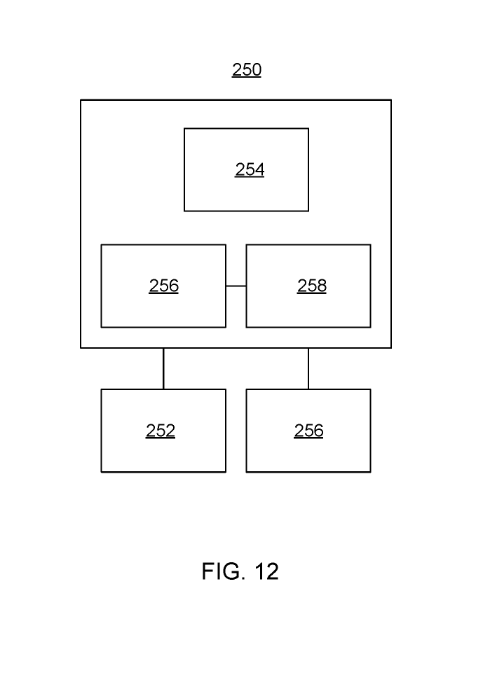

FIG. 12 shows details of a computing device 250 on which embodiments described above may be implemented. The host 102 shown in FIG. 1 is a computing device 250. The technical disclosures herein constitute sufficient information for programmers to write software, and/or configure reconfigurable processing hardware (e.g., FPGAs), and/or design application-specific integrated circuits (ASICs), etc., to run on one or more of the computing devices 120 to implement any of features or embodiments described in the technical disclosures herein.

The computing device 250 may have a display 252, a network interface 254 (or several), as well as storage hardware 256 and processing hardware 258, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 256 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 250 may cooperate in ways well understood in the art of computing. In addition, input devices may be integrated with or in communication with the computing device 250. The computing device 250 may have any form factor or may be used in any type of encompassing device. The computing device 250 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least storage hardware such as optical storage (e.g., compact-disk read-only memory (CD-ROM)), magnetic storage hardware, flash read-only memory (ROM), and the like. The information stored in storage hardware can be in the form of machine executable instructions (e.g., compiled executable binary code), source code, bytecode, or any other physical hardware having a physical state that can transfer information to processing hardware to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A computing device comprising:
processing hardware;
storage hardware storing instructions executable by the processing hardware, the instructions comprising:
an operating system comprising a network stack that implements a plurality of discovery protocols;
a discovery framework comprising a discovery user interface (UI) and a discovery engine configured to use the discovery protocols;
the discovery engine configured to respond to an invocation of the discovery framework by determining discovery criteria and based thereon selecting one of the discovery protocols, requesting discovery through the selected discovery protocol, receiving corresponding first discovery results, and maintaining a discovery list comprised of indicia of devices discovered through any of the discovery protocols; and
the discovery UI configured to allow interactive adjustment of the discovery criteria and configured to display the discovery list and respond to selection of a discovered device in the discovery list by enabling a connection with the discovered device based on a network address of the discovered device obtained through one of the discovery protocols, the discovery UI comprising an interactive element that, when activated, causes the discovery engine to select a second discovery protocol, request discovery through the selected second discovery protocol, receive corresponding second discovery results, and update the discovery list to indicate devices discovered through the second discover protocol, wherein the discovery list displayed by the discovery UI displays the devices discovered through the second discovery protocol.

2. A computing device according to claim 1, wherein the discovery protocol and the second discovery protocol comprise at least two of: an application-layer discovery protocol, a network-layer discovery protocol, and a link-layer discovery protocol.

3. A computing device according to claim 1, wherein the discovery engine is further configured to normalize the discovery results and the second discovery results into a namespace in which discovered devices are represented by respective single unique identifiers by identifying discovery results that correspond to a same device.

4. A computing device according to claim 1, wherein the discovery list comprises a representation of a first device discovered by the discovery protocol and comprises a representation of a second device discovered by the second discovery protocol, wherein both representations are configured to be interactively selected to initiate a connection to the corresponding devices.

5. A computing device according to claim 1, wherein the discovery framework comprises an application programming interface (API) invocable by arbitrary applications on the computing device.

6. A computing device according to claim 1, wherein the discovery UI comprises one or more UI elements configured to control filtering and/or ordering of the discovery list.

7. A computing device according to claim 1, wherein the discovery UI is configured to display an indication that additional devices have been discovered and the indication is configured to cause the additional devices to be displayed.

8. A computing device according to claim 1, wherein the devices in the discovery list are ordered according to proximity to the computing device.

9. A method performed by a computing device, the method comprising:
executing an operating system comprised of a network protocol stack, the network protocol stack implementing a plurality of discovery protocols;
displaying a user interface (UI) comprising a discovered-device area that displays discovered devices;
responding to an invocation of the UI by requesting one of the discover protocols to discover devices on a network and adding the discovered devices to the discovered-device area;
enabling interactive control of additional device discovery through the UI, wherein interactions with the UI modify discovery criteria and the discovery criteria control which discovery protocols are automatically selected to for discovering devices that are displayed in the discovered-device area; and
whenever a device is discovered from multiple discovery protocols, assuring that the device is represented no more than one time in the discovered-device are.

10. A method according to claim 9, further comprising displaying an indication that additional discovery is available and responding to an activation of the indication by requesting the network communication protocol stack to perform additional device discovery with an additional discovery protocol.

11. A method according to claim 9, further comprising a user interface element that displays filtering criteria and filtering which devices are displayed in the discovered-device area according to the filtering criteria.

12. A method according to claim 9, further comprising responding to a user input selecting a device in the discovered-device area by initiating a connection over the network.

13. A method according to claim 9, wherein devices in the discovered-device area are at least partly ordered according to indications of previous connections thereto by the computing device.

14. A method according to claim 9, wherein devices are displayed in the discovered-devices area in a same form regardless of which discovery protocol discovered which device, and wherein some devices in the discovered-device area were discovered at different layers of the network communication protocol stack.

15. A method according to claim 14, wherein the different layers include at least two of: the application layer, the network/transport layer, and the link/media layer.

16. A method according to claim 9, wherein types of discovered devices are identified and are used for ordering, filtering, discovering, and/or displaying information about discovered devices.

17. Computer-readable storage hardware storing information configured to enable a computing device to perform a process, the process comprising:
executing a discovery user interface (UI) functionally linked to a discovery engine;
displaying in the discovery UI indicia of devices discovered on a network through a plurality of discovery protocols implemented by a protocol stack of the computing device, the devices discovered by the discovery engine selecting the discovery protocols according to discovery criteria specified at least in part by the discovery UI;
based on a determination that additional devices are to be discovered, displaying additional indicia of devices discovered through the plurality of discovery protocols; and
responding to a user input selecting a device indicated by the indicia of devices by initiating a network connection between the selected device and the computing device.

18. Computer-readable storage hardware according to claim 17, wherein the displaying additional indicia of devices comprises selecting one of the discovery protocols and issuing a request to the selected discovery protocol.

19. Computer-readable storage hardware according to claim 17, wherein the process further comprises automatically dynamically adapting the discovery UI to enable interactive extension of device discovery using the discovery protocols.

20. Computer-readable storage hardware according to claim 17, the process further comprising reducing results from the discovery protocols to a coherent normalized device namespace, the reducing including consolidating results from the discovery protocols that correspond to same devices.
